(19) United States
(12) Patent Application Publication
(10) Pub. No.: US 2026/0210227 A1
(43) Pub. Date: Jul. 23, 2026

(54) Electro- Mechanical High-Pressure Oilfield Pumping System

(71) Applicant: Twin Disc, Inc., Racine, WI (US)

(72) Inventors: Steven Hall, Racine, WI (US); Andrew Conaty, West Allis, WI (US)

(21) Appl. No.: 19/456,776

(22) Filed: Jan. 22, 2026

Related U.S. Application Data
(60) Provisional application No. 63/748,780, filed on Jan. 23, 2025.

(51) Int. Cl. E21B 43/26; F04B 17/03; F04B 19/04; F16D 47/04; F16H 57/02; H02K 7/108; H02K 7/116; H02K 7/20

(52) U.S. Cl. CPC E21B 43/2607; F04B 17/03; F04B 19/04; F16D 47/04; F16H 57/02; H02K 7/108; H02K 7/116; H02K 7/20; F16H 2057/02034; F16H 2057/02073

(57) ABSTRACT

An electro-mechanical high-pressure oilfield pumping system includes a fracturing (frac) pump, a primary electric motor system, and an auxiliary electric motor system. The primary electric motor system includes a primary electric motor as a prime mover that delivers power to the frac pump. The auxiliary electric motor system includes an electric starting motor that may rotate a shaft of the primary electric motor to achieve or approximate its fixed rated speed before the primary electric motor is energized. The auxiliary electric motor system may further include an electric supplemental motor. The electric supplemental motor may assist the electric starting motor to rotate the shaft of the deenergized primary motor. The electric supplemental motor may also rotate the shaft of the primary electric motor as a passive torque transmission device that delivers power to the frac pump to perform sub-speed operations which may include slow-speed fracturing and/or hydraulic line testing.

### BACKGROUND OF THE INVENTION

### Field of the Invention

The preferred embodiments relate generally to the field of hydrocarbon recovery from the earth and, more specifically, to oilfield pressure pumping systems for fracturing underground formations to enhance recovery of hydrocarbons.

### Discussion of the Related Art

Hydraulically fracturing subterranean formations with oilfield pressure pumping systems to enhance flow in oil and gas wells is known. Hydraulic fracturing increases well productivity by increasing the porosity of, and thus flow rate through, production zones that feed boreholes of the wells that remove underground resources like oil and gas.

Oilfield pressure pumping systems include heavy-duty industrial-type components to create the extreme hydraulic pressures, for example, 10,000 psi or more, which are needed to fracture the subterranean geological formations. Positive displacement, high pressure, plunger pumps are used as fracturing (fracking or frac) pumps to generate the extreme hydraulic pressures that are capable of fracturing subterranean geological formations.

Flow and pressure of frac fluids from frac pumps must be closely regulated at the various fracturing stages in order to adequately control the fracturing process. Accordingly, prime movers that deliver power to the frac pumps are variable speed devices, since driving the frac pumps at variable speeds at least partially provides the flow and pressure control.

Typically, the prime movers are high horsepower stationary diesel engines that deliver power to the frac pumps through multi-speed gearboxes or transmissions. High horsepower stationary diesel engines are expensive and require maintenance and operational attention, such as refueling.

Other attempts have been made to use variable speed electric motors to power frac pumps. Variable speed electric motors are able to vary flow and pressure of the frac pumps through speed-varying motor controls, which facilitates control of the fracturing operation. Variable speed electric motors either directly drive the frac pumps at the motors'variable speeds or with an intervening single-speed gearbox or transmission. Such variable speed electric motors include shunt wound, variable speed, DC (direct current) traction motors and variable speed, for example, variable frequency, AC (alternating current) electric motors. Although variable speed electric motors can require less operational attention than high horsepower stationary diesel engines, those that are powerful enough to drive frac pumps are expensive and require sophisticated motor controls, including complicated large variable frequency drives for such large variable speed AC motors.

Constant speed AC motors are more straightforward than variable speed electric motors but have not been used to deliver power to frac pumps. That is because the fixed speed(s) of constant speed AC motors do not provide the desired amount of flow and pressure control of the frac pumps to allow operators to suitably control the fracturing operation. Typical multi-speed gearboxes are unable to resolve this problem with constant speed AC motors because they are unable to shift under full load and have range ratios that are ill-suited to provide a sufficient variety of output shaft speeds or corresponding frac pump flow and pressure control.

Furthermore, constant speed AC motors of high-enough horsepower ratings to power frac pumps are difficult to start because they require extremely high starting currents as in-rush (locked rotor) currents to begin their rotations.

What is therefore needed is a prime mover for high pressure pumping applications, like powering frac pumps, employing a constant speed AC motor, but without the above-noted drawbacks primarily directed to flow and pressure control.

### SUMMARY AND OBJECTS OF THE INVENTION

The preferred embodiments overcome the above-noted drawbacks by providing an electro-mechanical high-pressure pumping system that incorporates a constant speed AC motor. This can be incorporated as an electro-mechanical frac pump system for use in an oilfield pressure pumping system.

An electro-mechanical high-pressure oilfield pumping system includes a fracturing (frac) pump, a primary electric motor system, and an auxiliary electric motor system. The primary electric motor system includes a primary electric motor as a prime mover that delivers power to the frac pump. The primary electric motor may be a constant speed AC (alternating current) motor. The auxiliary electric motor system includes at least one auxiliary motor. The auxiliary motor may be implemented as an electric starting motor that may rotate a shaft of the primary electric motor to achieve or approximate its fixed rated speed before the primary electric motor is energized. Another auxiliary motor of the auxiliary electric motor system may be implemented as an electric supplemental motor. The electric supplemental motor may define a reduced output prime mover for the high-pressure oilfield pumping system and may assist the electric starting motor at times to rotate the shaft of the deenergized primary motor, as needed. The electric supplemental motor may rotate the shaft of the primary electric motor as a passive torque transmission device that delivers power in a downstream direction through a transmission and to the frac pump. This may allow the auxiliary electric motor system to provide power for rotating the shaft of the deenergized primary motor, such as pre-rotating the primary electric motor before energizing it and/or performing slow-speed fracturing or hydraulic line testing.

The system may define multiple modes of operation. In a primary electric motor starting mode, the auxiliary electric motor system's electric starting motor delivers power through the transmission to rotate the motor shaft of the primary electric motor to its fixed rated speed before being energized, which allows the primary electric motor to be started at essentially its normal running current instead of at a high in-rush starting current. The electric supplemental motor may assist the electric starting motor during at least a portion of this starting procedure, for example to provide supplemental torque to assist with initial rotation of the deenergized primary motor shaft. After initial rotation, the electric supplemental motor may be deenergized while the electric starting motor remains energized to increase the rotational speed of the primary electric motor's shaft to achieve its fixed rated speed. In a slow frac mode, the electric supplemental motor may deliver power through the transmission to rotate the motor shaft of the primary electric motor to a speed that is less than the fixed rated speed to the primary electric motor to drive the frac pump at a slower speed and provide high-pressure slow speed fracking. In a hydraulic test mode, the auxiliary electric motor system provides power to rotate the prime mover's shaft and drive the frac pump for evaluating performance or operational characteristics of system hydraulic lines. In a frac mode, the primary electric motor is energized and delivers power to the transmission into the frac pump.

According to a first embodiment, an electro-mechanical high-pressure oilfield pumping system for driving a fracturing (frac) pump is configured to pressurize a frac fluid for delivery into a well that extends into a subterranean geological formation. The system includes multiple cooperating electric motor systems, such as a primary electric motor system and an auxiliary electric motor system that individually or in combination provide different operational modes for the electro-mechanical high-pressure oilfield pumping system. In addition, the system preferably employs a transmission with multiple ranges that provide multiple drive ratios, the transmission being arranged between and configured to deliver power from the primary electric motor system and the auxiliary electric motor system to the frac pump. The auxiliary electric motor system may selectively deliver power through the transmission to rotate the motor shaft of the primary electric motor. In one operational mode, the auxiliary electric motor system rotates the primary motor's shaft to or to approach its operational or fixed rated speed as part of a motor startup procedure in which the primary electric motor is energized with its shaft already rotating at its fixed rated speed. In other operational modes, the primary electric motor's shaft may be a passive power transmitting component that is driven by the auxiliary electric motor system, transmitting power downstream through the transmission without the primary electric motor being energized.

In another aspect of this embodiment, the primary electric motor is a constant speed AC motor that defines a fixed rated speed, and moreover, the auxiliary electric motor system's electric starting motor is configured to rotate at a speed that corresponds to the fixed rated speed of the primary electric motor.

According to a further aspect of this embodiment, the auxiliary electric motor system's electric supplemental motor may selectively deliver power through the transmission to rotate the motor shaft of the primary electric motor. The primary electric motor is a constant speed AC motor that defines a fixed rated speed, and the electric supplemental motor is configured to rotate at a speed that is less than the fixed rated speed of the primary electric motor. This may include either rotating the electric supplemental motor's shaft at a slower rotational speed or reducing the rotational speed through a geared reduction downstream of the electric supplemental motor to rotate the primary electric motor's shaft below its rated speed.

In another embodiment, an electro-hydraulic high-pressure oilfield pumping system includes a fracturing (frac) pump configured to pressurize a frac fluid for delivery into a well that extends into a subterranean geological formation, and a primary electric motor that has a motor shaft and defines a prime mover of the electro-hydraulic high-pressure oilfield pumping system. A transmission with multiple ranges provides multiple drive ratios and is arranged between and configured to deliver power from primary electric motor to the frac pump. The primary electric motor may define an active mode and a passive mode. When in the active mode, the primary electric motor is energized and acts as a system prime mover for powering the frac pump. When in the passive mode, the primary electric motor is deenergized and, for example, its shaft acts as a driven-through power transmission component that transmits power from the auxiliary electric motor system to the transmission.

According to another embodiment, a method of fracking a subterranean formation using a primary electric motor includes the step of driving the primary electric motor with an auxiliary electric motor system and driving a frac pump with an output of the primary electric motor to facilitate fracking the subterranean formation. The method further includes selectively delivering power from the primary electric motor to the frac pump using a transmission.

In another aspect of this embodiment, the primary electric motor defines a first electric motor and the method further includes the step of, in a starting mode, energizing an electric motor of the auxiliary electric motor system as a second electric motor, and rotating a motor shaft of the primary electric motor with the second electric motor to a first speed that corresponds to a fixed rated speed of the primary electric motor. Preferably, the primary electric motor is a constant speed AC motor. Moreover, the method includes the step of, in a slow frac mode, energizing another electric motor of the auxiliary electric motor system as a third electric motor. The third electric motor selectively delivers power through the transmission to rotate the motor shaft of the primary electric motor to a second speed that is less than the fixed rated speed of the primary electric motor. This provides a slow-frac mode in which the frac pump is operated at a speed that is below that which can be achieved with the primary electric motor operating at its operational or fixed rated speed.

According to another embodiment, the system may incorporate at least one clutch within the auxiliary electric motor system to disconnect the transmission of power from the auxiliary electric motor system at various times, for example, when the primary electric motor is energized and goes on-line. The clutch may be an active clutch such as an actuatable clutch or a passive clutch such as an overrunning clutch. The auxiliary electric motor system may have multiple electric motors, each of which may have an associated clutch to connect or disconnect it relative to downstream components.

In another aspect of this embodiment, the auxiliary electric motor system may include at least one overrunning clutch implanted as a passive clutch. For implementations of auxiliary electric motor system that have multiple electric motors, a corresponding number of overrunning clutches may be provides to passively connect and disconnect power transmission with respect to the corresponding electric motor(s).

In another aspect of this embodiment, multiple electric motors of the auxiliary electric motor system may be simultaneously energized and deliver power downstream in the electro-mechanical high-pressure oilfield pumping system. According to one aspect, the primary motor startup procedure may be implemented in multiple steps, at least one of which may utilize multiple electric motors of the auxiliary electric motor system. A multi-staged overrunning strategy may be implemented to provide a stepped or sequential disengagement of the auxiliary electric motor system's electric motors. During an initial rotation stage of the primary motor startup procedure, both the electric starter motor and the electric supplemental motor may be energized to deliver power for initially rotating the primary electric motor's shaft. The electric supplemental motor may have a lower operational speed or maximum rotational speed than the electric starting motor, either as defined by the electric supplemental motor's shaft rotational speed or as applied to the transmission through a gear reduction. Accordingly, after such initial rotation stage, the electric starting motor may overrun the electric supplemental motor as facilitated by the electric supplemental motor's overrunning clutch. At this point, the auxiliary electric motor system automatically and passively switches from a shared rotation input for rotating the primary motor's shaft to a dedicated rotation input from the electric starting motor for rotating the primary motor's shaft. Once the primary electric motor's shaft achieves its operational or fixed rated speed, the primary electric motor may be energized and overrun the electric starting motor as a second automatic and passive auxiliary power disconnect event as facilitated by the electric starting motor's overrunning clutch.

These, and other aspects and objects of the present invention, will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical embodiments of the present invention, will become more readily apparent by referring to the exemplary and, therefore, non-limiting, embodiments illustrated in the drawings accompanying and forming a part of this specification, wherein like reference numerals designate the same elements in the several views, and in which:

FIG. 1 is a schematic illustration of an oilfield pressure pumping system incorporating electro-mechanical high-pressure pumping systems, shown incorporated as a frac pump system, according to a preferred embodiment;

FIG. 2 is a schematic illustration of an oilfield pressure pumping system incorporating electro-mechanical high-pressure pumping systems, shown incorporated as a frac pump system, according to another preferred embodiment;

FIG. 3 is a graphical representation of component performance characteristics during a startup mode of an oilfield pressure pumping system incorporating electro-mechanical high-pressure pumping systems, shown incorporated as a frac pump system, according to a further preferred embodiment;

FIG. 4 is a graphical representation of component performance characteristics during a slow frac or hydraulic line test mode of an oilfield pressure pumping system incorporating electro-mechanical high-pressure pumping systems, shown incorporated as a frac pump system, according to a further preferred embodiment;

FIG. 5 is a graphical representation of component performance characteristics during another startup mode of an oilfield pressure pumping system incorporating electro-mechanical high-pressure pumping systems, shown incorporated as a frac pump system, according to a further preferred embodiment; and

FIG. 6 is a graphical representation of component performance characteristics during another slow frac or hydraulic line test mode of an oilfield pressure pumping system incorporating electro-mechanical high-pressure pumping systems, shown incorporated as a frac pump system, according to a further preferred embodiment.

In describing preferred embodiments of the invention, which are illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected”, “attached”, “coupled”, or terms similar thereto are often used. They are not limited to direct connection but include connection through other elements where such connection is recognized as being equivalent by those skilled in the art.

### DETAILED DESCRIPTION OF PREFERRED EMBODIMENTS

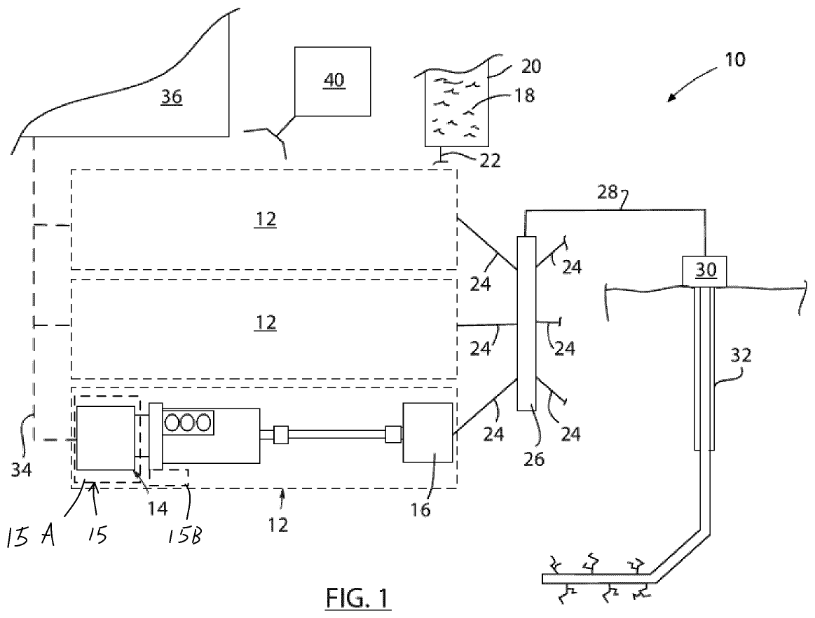

Referring to FIG. 1, one embodiment of the invention is shown as an electro-mechanical high-pressure pumping system 10. The electro-mechanical high-pressure pumping system 10 is shown here implemented as an electro-mechanical frac pumping system 12, which includes an electro-mechanical drive system 14 that includes multiple cooperating electric motor systems 15, shown as including a primary electric motor system 15A and auxiliary electric motor system 15B. Each of the motor systems 15 implements an electric motor(s) that may deliver power to a fracturing pump or frac pump 16 or other system components. Frac pump 16 can be a positive displacement, high-pressure, plunger pump or other suitable pump that can deliver high flow rates and produce high pressures, for example, 10,000 psi or more. This oilfield site is shown with multiple electro-mechanical frac pumping systems 12 that operate together for a subterranean geological formation fracturing or fracking operation to stimulate well production. The electro-mechanical frac pumping systems 12 can be activated or brought online and implemented separately or together, depending on the particular pumping needs for a given fracking operation or operational stage. Each of the electro-mechanical frac pumping systems 12 may define a singularly-packaged unit, for example, mounted on a trailer that can be towed by a semi-tractor or other tow vehicle. Each frac pump 16 receives fracturing fluid or frac fluid 18 that is stored in a frac fluid storage system 20 and delivers the frac fluid 18 to the frac pumps 16 through frac fluid delivery lines 22. Pressurized frac fluid 18 is delivered from the frac pumps 16, through manifold delivery lines 24, to manifold 26 that delivers the pressurized frac fluid 18 through manifold outlet line 28 to wellhead 30. At the wellhead 30, the frac fluid 18 is directed to flow through a borehole that extends through a well casing 32 for fracturing the subterranean formation.

Still referring to FIG. 1, electro-mechanical frac pumping system 12 selectively receives electrical power through conductors 34 from electrical power system 36. Electrical power system 36 includes a generator and prime mover such as a combustion engine which may be a gas turbine engine. Control system 40 includes a computer that executes various stored programs while receiving inputs from and sending commands to the electro-mechanical frac pumping system 12 for controlling, for example, energizing and de-energizing various system components as well as bringing the electro-mechanical frac pumping system 12 online for fracking the subterranean formations by controlling the various electronic, electromechanical, and hydraulic systems and/or other components of each electro-mechanical frac pumping system 12. Frac site control system 40 may include the TDEC-501 electronic control system available from Twin Disc®, Inc. for controlling the electro-mechanical frac pumping system(s) 12.

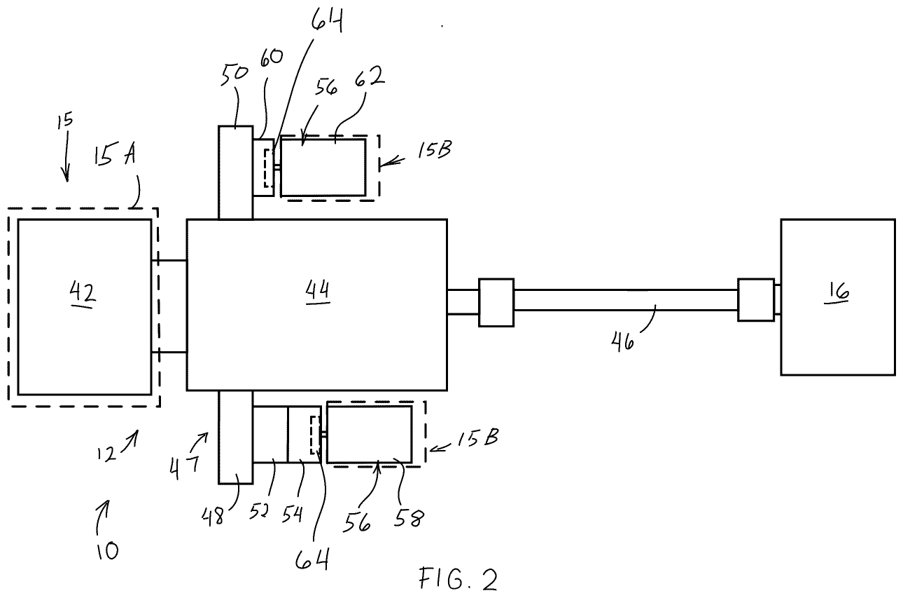

Referring now to FIG. 2, electro-mechanical frac pumping system 12 includes a constant speed AC motor, shown as primary electric motor 42. Primary electric motor 42 is a high-powered constant speed motor, for example, at least about 1,000 HP (horsepower) or having an equivalent torque rating of at least about a 1,000 HP diesel engine and which may be implemented as a medium voltage constant speed AC motor. Primary electric motor 42 typically has an HP rating of between 800 HP and 3,000 HP, more typically between 2,000 HP and 2,800 HP. The HP rating of primary electric motor 42 may be, for example, 800 HP, or 1,000 HP, or 1,500 HP, or 2,000 HP, or 2,500 HP, or 3,000 HP, or sub-values between these examples. Primary electric motor 42 operates at a relatively fast fixed rotational speed, such as a fixed rated speed of between about 1,200 RPM (rotations per minute) to 3,000 RPM, typically between 1,500 RPM and 2,000 RPM. The fixed rated speed of primary electric motor may be, for example, 1,200 RPM, or 1,500 RPM, or 1,800 RPM, or 2,200 RPM, or 2,500 RPM, or 2,800 RPM, or 3,000 RPM, or sub-values between these examples. Primary electric motor 42 is connected and delivers power to a heavy-duty industrial gearbox or transmission, shown as transmission 44. Transmission 44 may be a multi-speed transmission with multiple ranges that provide multiple substantially evenly spaced drive ratios to facilitate close regulation of rotational speed of the transmission output shaft and, correspondingly, the frac pump's 16 operational speed and output flow and pressure. Transmission 44 may be, for example, a model TA90-7600, available from Twin Disc®, Inc., which is capable of changing ranges while the frac pump 16 is fully loaded. Driveshaft 46 transmits torque from transmission 44 to frac pump 16.

Still referring to FIG. 2, transmission 44 includes a PTI/PTO (power-take-in/power-take-out) gearbox, shown as a tower or section 47 with a pair of mounting pads or pump pads 48, 50. Pump pads 48, 50 are typically configured as pump drive interfaces for the PTI/PTO gearbox for mounting and mechanically delivering power to or receiving power from various components, for example, hydraulic components. The lower illustrated pump pad 48 is shown supporting a pair of transmission pumps 52, 54 which may be configured to, for example, supply pressurized oil for transmission lubrication and controlling hydraulically actuated components within the transmission.

Still referring to FIG. 2, the illustrated auxiliary electric motor system 15B is shown with a pair of electric auxiliary motors 56. Each electric auxiliary motor 56 may be a PM (permanent magnet) motor that is sized based on its particular operation(s) within the overall electric motor system 15, based on corresponding required operation and duty cycle. Electric auxiliary motor(s) 56 may be controlled by a corresponding motor drive within the electro-mechanical frac pumping system 12. Each electric auxiliary motor 56 may have an HP rating between about 5% and 10% of the HP rating of the primary electric motor 42. Each electric auxiliary motor 56 typically has an HP rating of between 50 HP and 300 HP, more typically between 100 HP and 200 HP. The HP rating of each auxiliary motor 56 may be, for example, 50 HP, or 100 HP, or 150 HP, or 160 HP, or 180 HP, or 200 HP, or 250 HP, or 300 HP, or sub-values between these examples. The electric auxiliary motor 56 toward the bottom of section 47 is shown mounted to the transmission pumps 52, 54, and therefore transmission 44 by way of pump pad 48 and may define an electric starting motor 58. Electric starting motor 58 selectively delivers torque to rotate various gear train or other components of transmission 44 and correspondingly rotates the shaft of primary electric motor 42 when the primary electric motor 42 is de-energized. In this way, electric starting motor 58 can be activated to rotate primary electric motor 42 shaft to bring it sufficiently close to its rated fixed speed or synchronous speed before the primary electric motor 42 is energized. For example, if the fixed rated speed of primary electric motor 42 is 3,000 RPM, then electric starting motor 58 can correspondingly rotate at about 3,000 RPM or at an appropriate speed that can rotate the primary electric motor 42 shaft at 3,000 RPM or other speed, depending on the particular rated or synchronous speed of primary electric motor 42. Rotating the primary electric motor 42 with electric starting motor 58 to achieve the synchronous speed of primary electric motor 42 allows connection to the electrical power source DoL (Direct on Line) while avoiding the motor's high in-rush (locked rotor) current that would otherwise be required to start the primary electric motor 42. The primary electric motor 42 is therefore able to be started at essentially its normal running current, when pre-driven to its synchronous speed by electric starting motor 58.

Still referring to FIG. 2, the electric auxiliary motor 56 toward the top of section 47 is shown mounted to an intermediary gearbox 60 that is connected to pump pad 50 and may define an electric supplemental motor 62. Like electric starting motor 58, electric supplemental motor 62 may rotate various gear train or other components of transmission 44 to correspondingly rotating the shaft of primary electric motor 42 when it is deenergized. At times, electric supplemental motor 62 may be rotated to assist the electric starting motor's 58 pre-rotation of the primary electric motor's 42 shaft or electric supplemental motor 62 may deliver power for driving rotation of the deenergized primary motor shaft to perform slow-speed fracturing or hydraulic line testing at speeds below the primary electric motor's 42 fixed rated speed. Electric supplemental motor 62 may have a higher HP rating than the electric starting motor 58. Typically, electric supplemental motor 62 is sized, either alone or in combination with intermediary gearbox 60 if so equipped, to produce the torque required to achieve maximum pump pressure of frac pump 16. The rotational speed of electric supplemental motor 62 and/or an output of intermediary gearbox 60 may be a fraction of the rotational speed of electric starting motor 58 and the fixed rated speed of primary electric motor 42. Electric supplemental motor 62 can be energized to deliver power to rotate primary electric motor's 42 shaft at slow and precisely controlled speeds to deliver torque through the transmission 44 and correspondingly precisely control the frac pump 16 to provide high-pressure low speed fracking. Such rotational speed of electric supplemental motor and/or the output of intermediate gearbox 60 may be between about 800 RPM to 1,100 RPM or at an appropriate speed that can rotate the primary electric motor 42 shaft at between about 800 RPM to 1,000 RPM or other speed, depending on the particular speed(s) required to produce the desired flow rate of frac pump 16 for high pressure low speed fracking. Regardless, the precise slow speed control of electric supplemental motor 62 may be achieved using a closed-loop controller (for example, proportional integral derivative (PID) controller) within the control system 40 (FIG. 1) that controls the electric supplemental motor 62.

Still referring to FIG. 2, a pair of coupler arrangements that many include a corresponding pair of clutches 64 is shown arranged between electric starting motor 58 and pump pad 48 and electric supplemental motor 62 and pump pad 50, with each configured to disconnect power transfer between the respective electric auxiliary motor 56 and transmission 44. Clutch 64 may be an overrunning clutch or an actuatable or other clutch to passively or actively connect or disconnect power flow between the electric motor system 15 and transmission 44 to correspond to different operational states of the high-pressure pumping system 10.

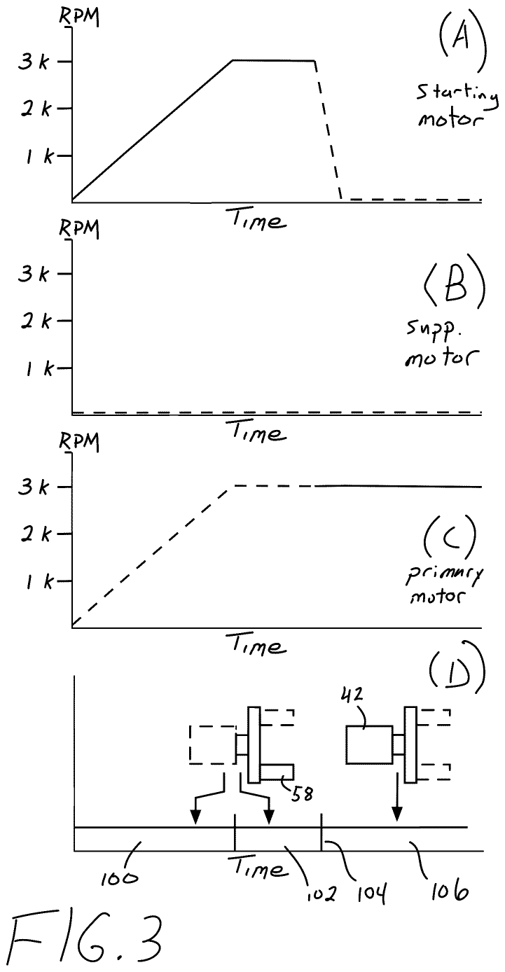

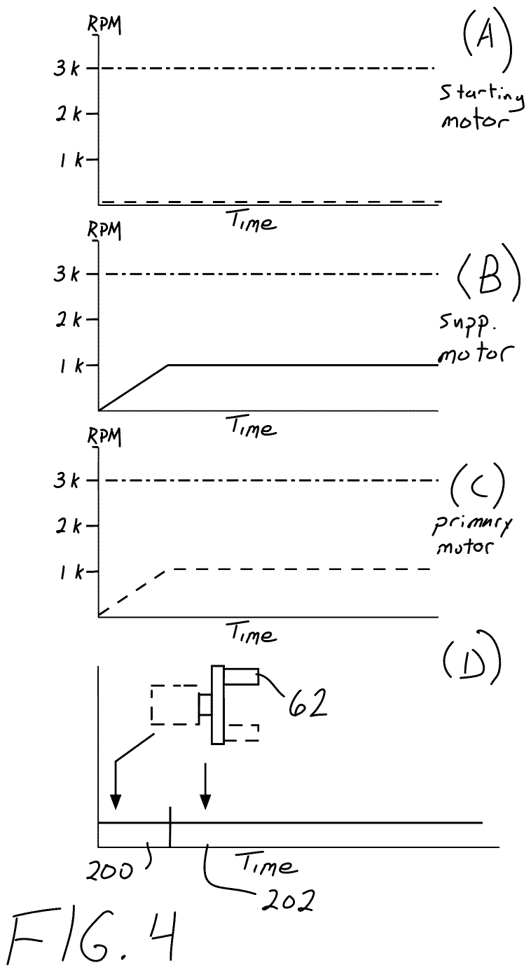

Referring generally to FIGS. 3 and 4 and with background reference to FIG. 2, each of electric auxiliary motors 56 may be discretely operated independently of each other during different operational modes. For example, FIGS. 3 and 4 represent electric starting motor 58 solely delivering power to perform the pre-rotation of the deenergized primary electric motor 42 (FIG. 3) and electric supplemental motor 62 solely delivering power to perform the slow frac or hydraulic line testing operation(s) through the deenergized primary electric motor 42 (FIG. 4).

Referring now to FIG. 3, graphs (A)-(C) represent shaft rotational speed (Y-axis) of the electric starting motor 58 (A), electric supplemental motor 62 (B), and primary motor 42 (C) as a function of time (X-axis). Graph (D) schematically represents energized (solid lines) and deenergized (dashed lines) components of electric motor system 15 along the same time interval represented in graphs (A)-(C). FIG. 3 represents a methodology with a primary electric motor 42 that has a fixed rated speed of about 3,000 RPM. In a preliminary pre-rotation phase 100, primary electric motor 42 is or remains deenergized and electric starting motor 58 is energized. The electric starting motor's 58 rotational speed increases toward the fixed rated speed of primary electric motor 42, shown here as 3,000 RPM. Electric supplemental motor 62 remains deenergized and does not rotate, which may include it being passively overrun by coupler components or other downstream components as facilitated by, for example, its respective overrunning clutch implementation of clutch 64. During a changeover phase 102, electric starting motor 58 and the primary electric motor 42 achieve a target speed, shown here corresponding to the fixed rated speed of primary electric motor 42. Upon detection of achieving the target speed, control system 40 commands energizing primary electric motor 42 at changeover event 104, which may also include commanding deenergizing electric starting motor 58. Electric starting motor 58 may coast down toward non-rotation, which may include being passively overrun by coupler components or other downstream components as facilitated by, for example, its respective overrunning clutch implementation of clutch 64.

Referring now to FIG. 4, like FIG. 3, graphs (A)-(C) represent shaft rotational speed (Y-axis) as a function of time (X-axis) of the electric starting motor 58 (A), electric supplemental motor 62 (B), and primary motor 42 (C) and graph (D) schematically represents energized (solid lines) and deenergized (dashed lines) components, with a primary electric motor 42 that has a fixed rated speed of about 3,000 RPM. FIG. 4 represents a sub-speed operation, such as a slow speed frac mode or a hydraulic line testing mode. In a preliminary phase 200, primary electric motor 42 is or remains deenergized and electric supplemental motor 62 is energized. The electric supplemental motor's 62 rotational speed increases toward a sub-fixed rated target speed, relative to primary electric motor's 42 fixed rated speed, shown here as 3,000 RPM. Electric starting motor 58 remains deenergized and does not rotate, which may include it being passively overrun by coupler components or other downstream components as facilitated by, for example, its respective overrunning clutch implementation of clutch 64. At sub-fixed rated speed phase 202, control system 40 detects the electric supplemental motor 62 and/or primary electric motor 42 achieving the target speed for the mode and maintains the corresponding driving speed from electric supplemental motor 62, which may correspond to its maximum speed.

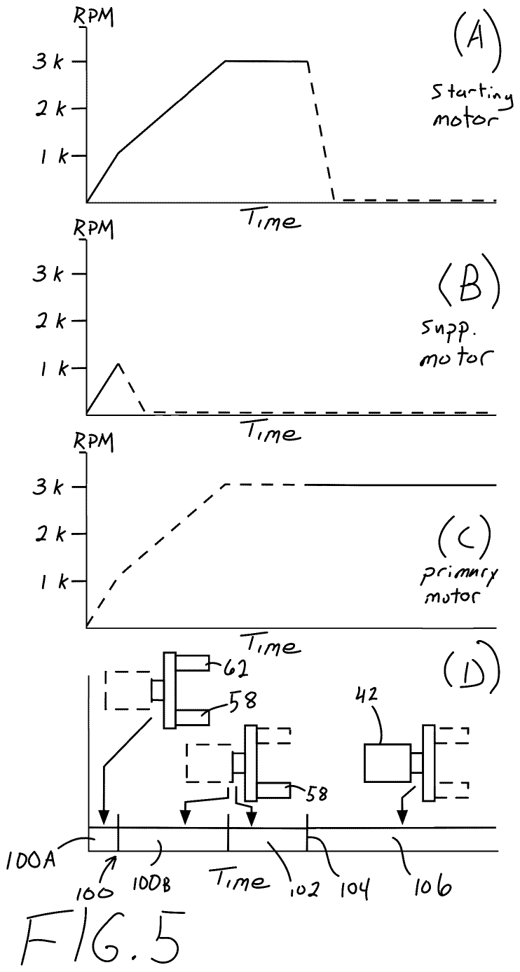

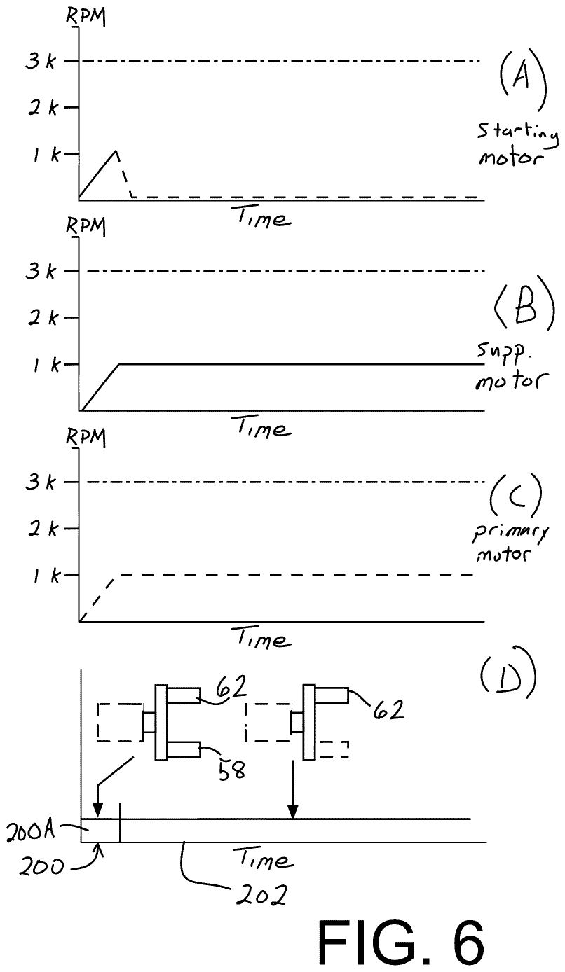

Referring generally to FIGS. 5 and 6 and with continued background reference to FIG. 2, electric auxiliary motors 56 may be simultaneously operated during at least portions of different operational modes. For example, FIGS. 5 and 6 represent electric starting motor 58 and electric supplemental motor 62 initially providing power simultaneously to, for example, begin pre-rotation of the primary motor 42 for initiating either a fixed-rated-speed normal frac mode (FIG. 5) or a sub-fixed-rated speed slow frac mode or hydraulic line testing mode (FIG. 6).

Referring now to FIG. 5, this methodology or procedure is substantially the same as that described in FIG. 3. A difference is that during the preliminary pre-rotation phase 100, an initial supplemental stage 100A includes energizing both the electric starting motor 58 and the electric supplemental motor 62. The initial supplemental stage 100A may continue until electric supplemental motor 62 achieves its maximum speed. At this point, control system 40 may deenergize electric supplemental motor 62, allowing it to coast down to a stop and be overrun by coupler components or other downstream components as permitted by, for example, its associated overrunning clutch.

Referring now to FIG. 6, this methodology or procedure is substantially the same as that described in FIG. 4. A difference is that during the preliminary phase 200, an initial supplemental stage 200A includes energizing both the electric starting motor 58 and the electric supplemental motor 62. The initial supplemental stage 200A may continue until electric supplemental motor 62 achieves its maximum speed for performing, for example, a slow speed frac or hydraulic line test(s). At this point, control system 40 may deenergize electric starting motor 58, allowing it to coast down to a stop and be overrun by coupler components or other downstream components as permitted by, for example, its associated overrunning clutch.

Although the best mode contemplated by the inventors of carrying out the present invention is disclosed above, practice of the above invention is not limited thereto. It will be manifest that various additions, modifications, and rearrangements of the features of the present invention may be made without deviating from the spirit and the scope of the underlying inventive concept.

We claim:

1. An electro-mechanical high-pressure oilfield pumping system for driving a fracturing (frac) pump configured to pressurize a frac fluid for delivery into a well that extends into a subterranean geological formation, comprising:
a primary electric motor system that includes a primary electric motor that has a motor shaft and defines a prime mover of the electro-mechanical high-pressure oilfield pumping system;
a transmission system that includes a transmission with multiple ranges that provide multiple drive ratios, the transmission arranged between and configured to deliver power from primary electric motor to the frac pump; and
an auxiliary electric motor system that includes at least one auxiliary electric motor mounted to the transmission system that delivers power through the transmission system to rotate the motor shaft of the primary electric motor.

2. The system of claim 1, wherein the primary electric motor is a constant speed AC (alternating current) motor that defines a fixed rated speed.

3. The system of claim 2, wherein the fixed rated speed of the primary electric motor is between 1200 RPM (rotations per minute) and 3000 RPM.

4. The system of claim 2, wherein the fixed rated speed of the primary electric motor is between 1500 RPM and 2000 RPM.

5. The system of claim 2, wherein:
the transmission system includes a PTI/PTO (power-take-in/power-take-off) gearbox with at least a pair of mounting pads; and
the auxiliary electric motor system includes at least a pair of auxiliary electric motors respectively mounted to the mounting pads of the PTI/PTO gearbox.

6. The system of claim 5, wherein:
each of the mounting pads is defined by a pump pad of the of the PTI/PTO gearbox that provides a pump drive interface for the PTI/PTO gearbox.

7. The system of claim 6, wherein:
at least one of the auxiliary electric motors is directly mounted to the respective mounting pad of the PTI/PTO gearbox.

8. The system of claim 6, wherein:
at least one of the auxiliary electric motors is mounted to the respective mounting pad of the PTI/PTO gearbox through an intermediary gearbox.

9. The system of claim 8 wherein:
the intermediary gearbox between the auxiliary electric motor and the PTI/PTO gearbox is a torque increasing/speed reducing intermediary gearbox.

10. The system of claim 6, wherein:
the HP (horsepower) rating of each of the auxiliary electric motors is between 5% and 10% of the HP rating of the primary electric motor.

11. The system of claim 6, wherein:
a coupler arrangement is defined between each auxiliary electric motor and the PTI/PTO gearbox; and
at least one of the coupler arrangements includes an overrunning clutch configured to allow the pump drive to rotate faster than the respective auxiliary electric motor.

12. The system of claim 11, wherein:
each coupler arrangement includes an overrunning clutch configured to allow each pump drive to rotate faster than its respective auxiliary electric motor.

13. The system of claim 12, wherein:
the PTI/PTO gearbox includes a first pump pad and a second pump pad;
a first overrunning clutch is arranged between the first pump pad and a first overrunning clutch;
a second overrunning clutch is arranged between the second pump pad and the second overrunning clutch;
the first auxiliary electric motor defines a maximum operational speed at which it delivers power to the first pump pad; and
the second auxiliary electric motor defines a maximum operational speed at which it delivers power to the second pump pad; and
wherein the maximum operational speed of the second auxiliary electric motor is less than the maximum operational speed of the first auxiliary electric motor.

14. The system of claim 13, wherein:
the first auxiliary electric motor defines an electric starting motor that delivers power through the PTI/PTO gearbox to rotate the motor shaft of the primary electric motor to the fixed rated speed when the primary electric motor is deenergized;
the second auxiliary electric motor defines an electric supplemental motor that delivers power through the PTI/PTO gearbox to rotate the motor shaft of the primary electric motor to a speed that is less than the fixed rated speed before the primary electric motor is deenergized.

15. The system of claim 14, wherein:
the auxiliary electric motor system defines a multi-staged overrunning arrangement with different overrunning speeds defined by the overrunning clutches associated with the electric starting motor and the electric supplemental motor as a function of operational speeds of the electric starting motor and the electric supplemental motor.
